(19) United States
(12) Patent Application Publication
(10) Pub. No.: US 2003/0037016 A1
(43) Pub. Date: Feb. 20, 2003

(54) Method and apparatus for representing and generating evaluation functions in a data classification system

(75) Inventors: Ricardo Vilalta, Stamford, CT (US); Mark Brodie, Briarcliff, NY (US); Daniel Oblinger, New York, NY (US); Irina Rish, White Plains, NY (US)

Correspondence Address: Ryan, Mason & Lewis, LLP, Suite 205, 1300 Post Road, Fairfield, CT, 06430, US

(73) Assignee: International Business Machines Corporation, Armonk, NY

(21) Appl. No.: 09/906,168

(22) Filed: Jul. 16, 2001

(51) Int. Cl. G06N 5/02

(52) U.S. Cl. 706/47

(57) ABSTRACT

A unified framework is disclosed for representing and generating evaluation functions for a classification system. The disclosed unified framework provides evaluation functions having characteristics of both traditional or purity-based evaluation functions (class uniformity) and discrimination-based evaluation functions (discrimination power). The disclosed framework is based on a set of configurable parameters and is a function of the distance between examples. By varying the choice of parameters and the distance function, more emphasis is placed on either the class uniformity or the discrimination power of the induced example subsets. A user-configurable function is used to score each of the features based on the class uniformity and discrimination power measures and thereby select the feature having a highest score to partition the data (e.g., using a decision tree or rule-base). This process is recursively applied until all of the examples are partitioned.

### FIELD OF THE INVENTION

The present invention relates generally to the fields of data mining or machine learning and, more particularly, to methods and apparatus for generating evaluation functions in a decision-tree or rule-based classification system.

### BACKGROUND OF THE INVENTION

Data classification techniques, often referred to as supervised learning, attempt to find an approximation or hypothesis to a target concept that assigns objects (such as processes or events) into different categories or classes. Data classification can normally be divided into two phases, namely, a learning phase and a testing phase. The learning phase applies a learning algorithm to training data. The training data is typically comprised of descriptions of objects (a set of feature variables) together with the correct classification for each object (the class variable).

The goal of the learning phase is to find correlations between object descriptions to learn how to classify the objects. The training data is used to construct models in which the class variable may be predicted in a record in which the feature variables are known but the class variable is unknown. Thus, the end result of the learning phase is a model or hypothesis (e.g., a set of rules) that can be used to predict the class of new objects. The testing phase uses the model derived in the training phase to predict the class of testing objects. The classifications made by the model are compared to the true object classes to estimate the accuracy of the model.

Data classifiers have a number of applications that automate the labeling of unknown objects. For example, astronomers are interested in automated ways to classify objects within the millions of existing images mapping the universe (e.g., differentiate stars from galaxies). Learning algorithms have been trained to recognize these objects in the training phase, and used to predict new objects in astronomical images. This automated classification process obviates manual labeling of thousands of currently available astronomical images.

One popular classification algorithm in machine learning is called decision-tree learning. Decision-tree learning algorithms often perform well on many domains and are efficient (running time on average grows linearly with the size of the input) and easy to implement. A key component in the mechanism of decision-tree learning algorithms is an evaluation function that measures the quality of some aspect of the final output model. In particular, the evaluation functions have a strong influence on the quality of the final hypothesis. Each field or column in a classification dataset corresponds to a feature describing a specific characteristic of each of the objects or examples. An evaluation function measures the quality in the partitions induced by each of the available features (or functions of features) on a set of training examples. A decision tree is constructed by choosing the highest-quality feature at each tree node.

Evaluation functions for decision-tree learning can generally be divided into two categories. The most common category is referred to as traditional or purity-based evaluation functions. Traditional or purity-based evaluation functions use the proportion of classes on the example subsets induced by each feature. The best result is obtained if each example subset is class uniform (i.e., comprise examples of the same class). For a discussion of traditional or purity-based evaluation metrics, see, e.g., J. R. Quinlan, Induction of Decision Trees, Machine Learning, 1, 81-106 (1986); J. R. Quinlan, C4.5: Programs for Machine Learning, Morgan Kaufmann Publishers, Inc. (1994); J. R. Quinlan, Oversearching and Layered Search in Empirical Learning, IJCAI-95, 1019-1024, Morgan Kaufmann (1995); J. Mingers, An Empirical Comparison of Selection Measures for Decision-Tree Induction, Machine Learning, 3, 319-342 (1989); or L. Breiman et al., Classification and Regression Trees, Belmont, Calif., Wadsworth (1994).

A second category of metrics is referred to as discrimination-based evaluation functions. Discrimination-based evaluation functions quantify the ability of a feature to discriminate among examples of different classes. The design of these metrics is centered on the ability of a feature to separate examples of different classes. For a discussion of discrimination-based evaluation functions, see, e.g., S. J. Hong, Use of Contextual Information for Feature Ranking and Discretization, IEEE Transactions of Knowledge and Data Engineering (1997) or K. Kira & L. Rendell, A Practical Approach to Feature Selection, Proc. of the Ninth Int'l Workshop on Machine Learning, 249-256, Morgan Kaufmann, Inc. (1997). Generally, most research in this area is found in the context of feature selection as a pre-processing step to classification.

Most evaluation functions capture only a limited amount of information regarding the quality of a model. Traditional or purity-based functions are unable to detect the relevance of a feature when its contribution to the target concept is hidden in combination with other features, also know as the feature-interaction problem. See, e.g., S. J. Hong, referenced above, or E. Perez & L. A. Rendell, Using Multidimensional Projection to Find Relations, Proc. of the Twelfth Int'l Conf. on Machine Learning, 447-455 (1995). In the feature-interaction problem, the class label of an example can be determined only if the interacting features are all known. To attack the feature-interaction problem additional information other than searching for subsets of examples with same class is required.

Discrimination-based functions look exclusively at the discrimination power of each feature, i.e., the ability of a feature to discriminate examples of different class. Discrimination-based metrics have proved effective in the context of feature selection as a pre-processing step to classification. Their design, however, overlooks the degree of class uniformity of the examples subsets induced by a feature. Discrimination power is the only criterion under consideration.

A need therefore exists for an improved system and method for building a decision tree using a new family of evaluation functions that combines the strengths of both traditional and discrimination-based metrics during classification. A further need exists for a unified framework for representing evaluation metrics in classification that allows the relevance of a feature to be observed in combination with other features. Yet another need exists for a unified framework for representing evaluation metrics in classification that covers a large space of possible models and increases the likelihood of identifying an appropriate model for a given set of data.

### SUMMARY OF THE INVENTION

Generally, a unified framework is disclosed for representing and generating evaluation functions for a data classification system. The disclosed unified framework provides evaluation functions having characteristics of both traditional or purity-based evaluation functions (class uniformity) and discrimination-based evaluation functions (discrimination power). The disclosed framework is based on a set of configurable parameters and is a function of the distance between examples. By varying the choice of parameters and the distance function, more emphasis is placed on either the class uniformity or the discrimination power of the induced example subsets. The disclosed framework unveils a space of evaluation functions with additional and more accurate models than was possible with conventional techniques.

An evaluation function is generated in accordance with the unified framework of the present invention by specifying configurable values for four different parameters. The first parameter is an impurity measure, F, that characterizes the quality of the partitions induced by each of the candidate features on the domain dataset. The second parameter is a weight vector, θ, that indicates the weight given to the class uniformity and discrimination power for partitioning of the domain dataset. The third parameter is a weight distance, α, that varies the relative importance of the distance between any two examples. In other words, large values for α narrow attention to only the closest neighboring examples while small values for α extend attention to examples lying far apart. The fourth parameter is the update factor, f_{α}, that is a distance function between examples (rows) in the domain dataset. A specific setting for these four parameters can generate all forms of traditional and discrimination-based functions.

Generally, the present invention provides evaluation functions that can be used to partition a domain dataset having a plurality of examples that are characterized by at least one feature and one class value. Initially, the present invention evaluates both a class uniformity measure and a discrimination power measure for each of the examples for every possible feature value. The user can specify a weight to be allocated to the class uniformity and discrimination power measures. A user-configurable function is used to score each of the features based on both the class uniformity and discrimination power measures and thereby select the feature having a highest score to partition the data (e.g., using a decision tree or rule base). This process is recursively applied until all of the examples are partitioned.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram showing the architecture of an illustrative data classification system in accordance with the present invention;

FIG. 2 illustrates the operation of the data classification system;

FIG. 3 illustrates an exemplary table from the domain dataset of FIG. 1;

FIG. 4 is a flow chart describing the decision-tree learning algorithm of FIG. 1;

FIG. 5 is a flow chart describing the evaluation function generation process of FIG. 1;

FIG. 6 is a flow chart describing the details of the feature ranking subroutine implemented by the decision-tree learning algorithm of FIG. 4;

FIG. 7 is a flow chart describing the details of the feature selection/node creation subroutine implemented by the decision-tree learning algorithm of FIG. 4;

FIG. 8 is a flow chart describing the details of the example discrimination subroutine implemented by the decision-tree learning algorithm of FIG. 4;

FIG. 9 is a flow chart describing the details of the recursive decision tree subroutine implemented by the decision-tree learning algorithm of FIG. 4;

FIG. 10a illustrates the possible scenarios in terms of the class agreement between a pair of examples;

FIG. 10b is a count matrix storing the counts for each of the four cases involving examples in class r for the two class situation of FIG. 10a; and

FIG. 11 describes pseudocode that computes the set of matrices {Rₘ} for the count matrix of FIG. 10b.

### DETAILED DESCRIPTION OF PREFERRED EMBODIMENTS

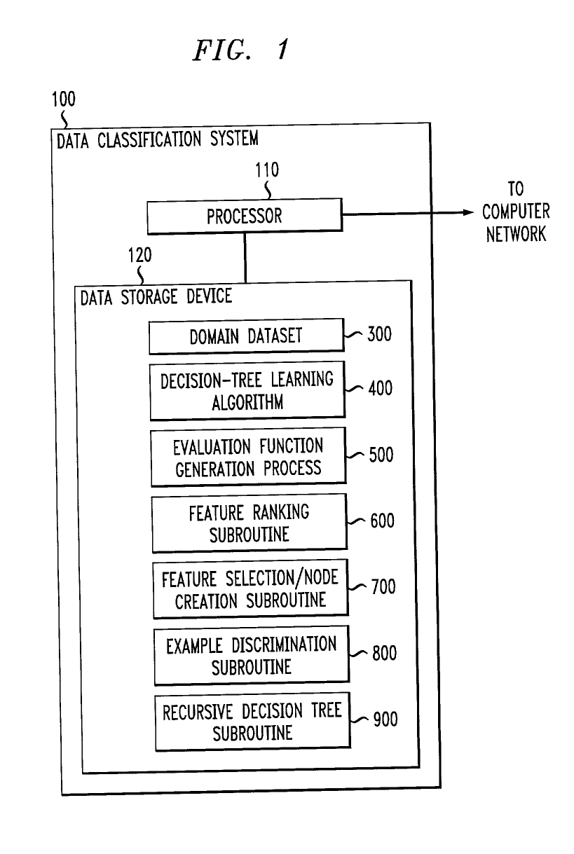

The present invention recognizes that discrimination-based metrics deserve particular attention because of their ability to address the high interaction problem, in which the relevance of a feature can be observed only in combination with other features. FIG. 1 illustrates a data classification system 100 in accordance with the present invention. The data classification system 100 may be embodied as a conventional data classification system implemented on a general purpose computing system, such as the learning program described in J. R. Quinlan, C4.5: Programs for Machine Learning, Morgan Kaufmann Publishers, Inc. Palo Alto, Calif., incorporated by reference herein, as modified in accordance with the features and functions of the present invention.

The data classification system 100 includes a processor 110 and related memory, such as a data storage device 120, which may be distributed or local. The processor 110 may be embodied as a single processor, or a number of local or distributed processors operating in parallel. The data storage device 120 and/or a read only memory (ROM) are operable to store one or more instructions, which the processor 110 is operable to retrieve, interpret and execute. As shown in FIG. 1, the data classification system 100 optionally includes a connection to a computer network (not shown).

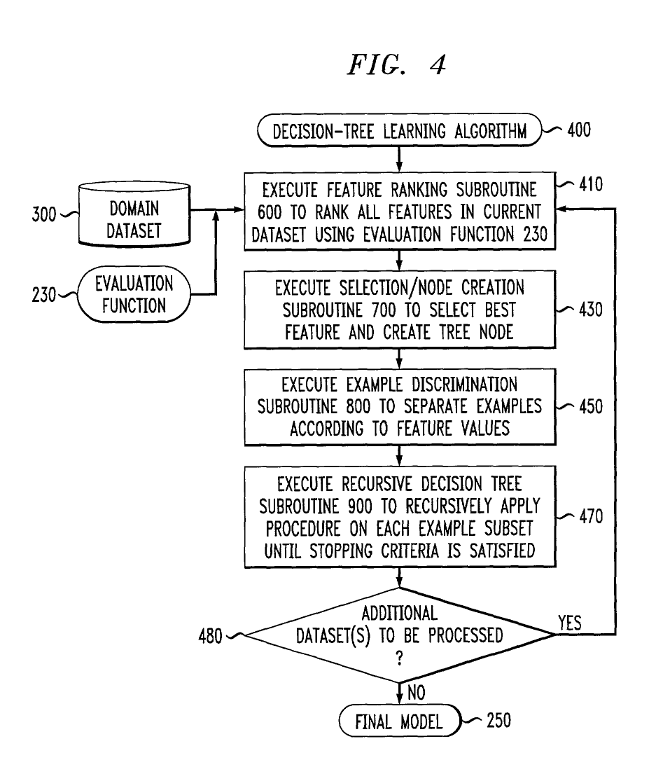

As shown in FIG. 1 and discussed further below in conjunction with FIG. 3, the data storage device 120 preferably includes a domain dataset 300 that contains a record for each object and indicates the class associated with each object. In addition, as discussed further below in conjunction with FIGS. 4 through 9, the data storage device 120 includes a decision-tree learning algorithm 400, an evaluation function generation process 500, a feature ranking subroutine 600, a feature selection/node creation subroutine 700, an example discrimination subroutine 800 and a recursive decision tree subroutine 900.

Generally, the decision-tree learning algorithm 400 produces a model in the form of a tree graph that may be utilized to classify a given dataset. The evaluation function generation process 500 incorporates features of the present invention to generate one or more evaluation functions using the unified framework. The decision-tree learning algorithm 400 initiates the feature ranking subroutine 600, feature selection/node creation subroutine 700, example discrimination subroutine 800 and recursive decision tree subroutine 900.

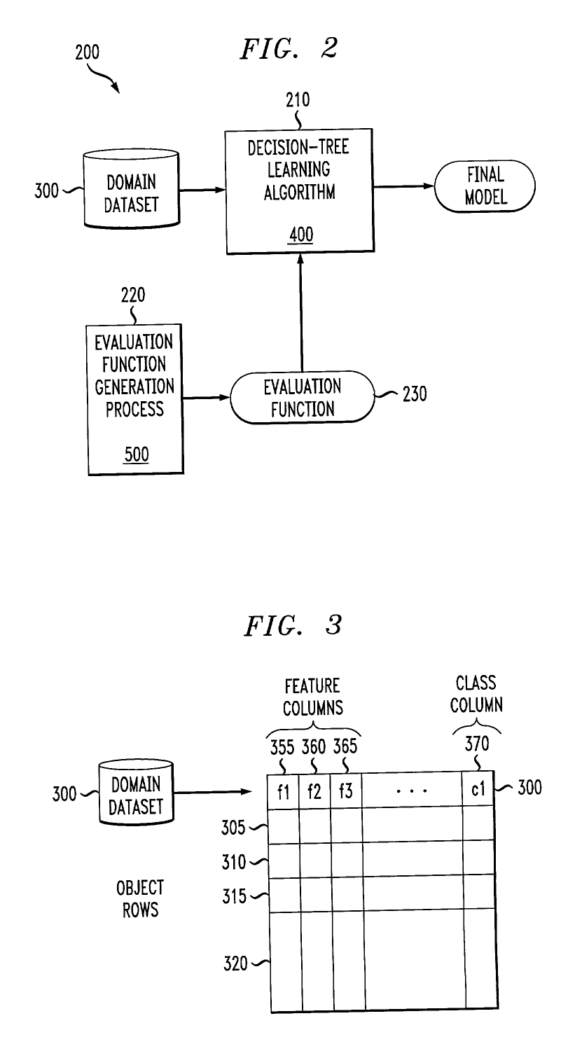

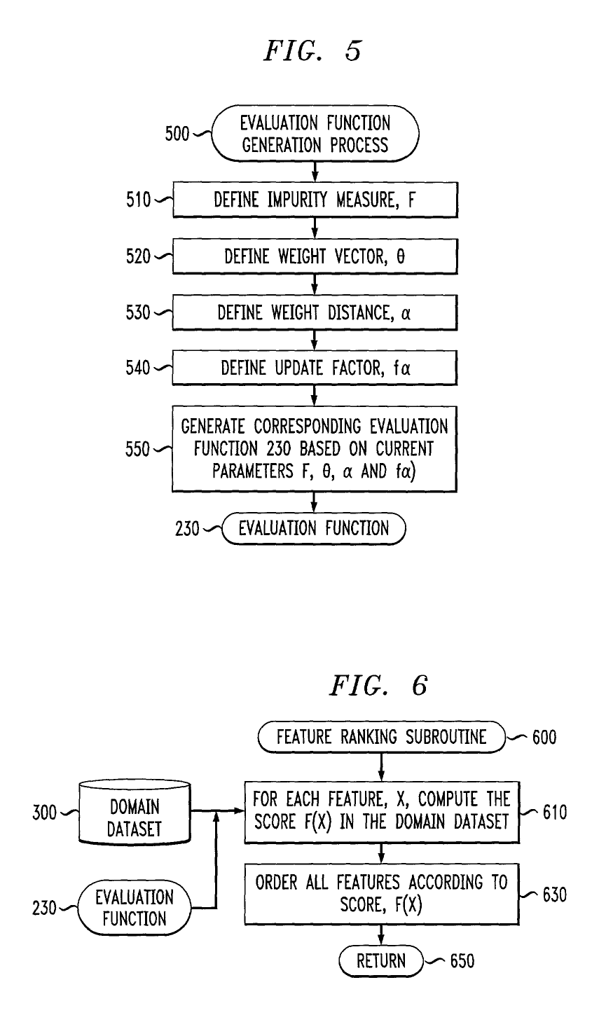

FIG. 2 provides a global view of the data classification system 100. As shown in FIG. 2, a domain dataset 300, discussed below in conjunction with FIG. 3, serves as input to the system 100. The domain dataset 300 is applied to the decision-tree learning algorithm 400, discussed below in conjunction with FIG. 4, during step 220. The decision-tree learning algorithm produces a model 250 that can be used to predict the class labels of future examples. In addition to the domain dataset 300, the decision-tree learning algorithm 400 processes an evaluation function 230 generated by the evaluation function generation process 500, discussed below in conjunction with FIG. 5, during step 220. The evaluation function 230 is used to classify the objects in the domain dataset 300. For a detailed discussion of suitable models 250, see, for example, J. R. Quinlan, C4.5: Programs for Machine Learning. Morgan Kaufmann Publishers, Inc. Palo Alto, Calif.. (1994) (decision trees); Weiss, Sholom and Indurkhya, Nitin, “Optimized Rule Induction”, Intelligent Expert, Volume 8, Number 6, pp. 61-69, 1993 (rules); and L. R. Rivest, “Learning Decision Lists”, Machine Learning, 2, 3, 229-246, (1987) (decision lists), each incorporated by reference herein.

FIG. 3 illustrates an exemplary table from the domain dataset 300 that includes training examples, each labeled with a specific class. As previously indicated, the domain dataset 300 contains a record for each object and indicates the class associated with each object. The domain dataset 300 maintains a plurality of records, such as records 305 through 320, each associated with a different object. For each object, the domain dataset 300 indicates a number of features in fields 350 through 365, describing each object in the dataset. The last field 370 corresponds to the class assigned to each object. For example, if the domain dataset 300 were to correspond to astronomical images to be classified as either stars or galaxies, then each record 305-320 would correspond to a different object in the image, and each field 350-365 would correspond to a different feature, such as the amount of luminosity, shape or size. The class field 370 would be populated with the label of “star” or “galaxy.”

### PROCESSES

FIG. 4 is a flow chart describing the decision-tree learning algorithm 400. As previously indicated, the decision-tree learning algorithm 400 produces a model in the form of a tree graph that may be utilized to classify a given dataset. Generally, the decision-tree learning algorithm 400 proceeds top-down.

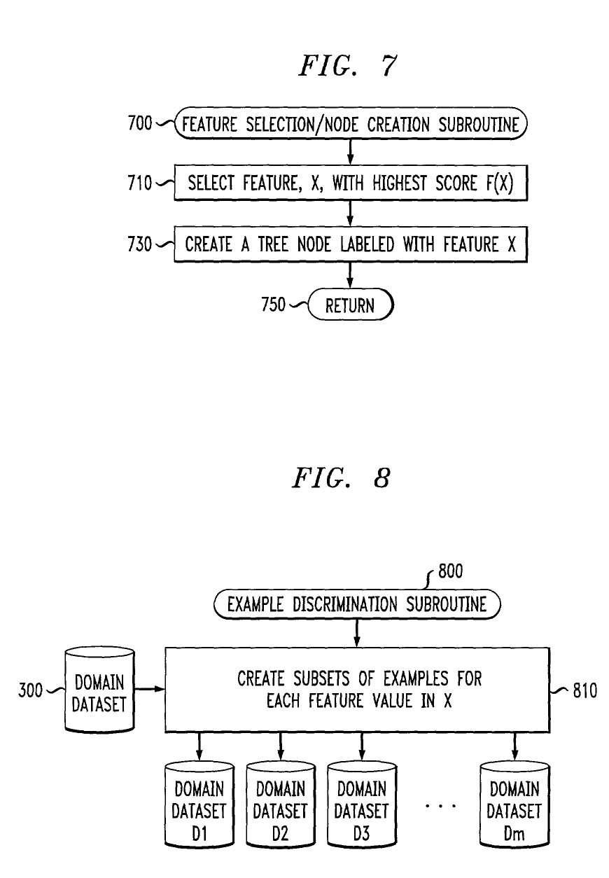

As shown in FIG. 4 and previously indicated, the decision-tree learning algorithm 400 receives the domain dataset 300 and the evaluation function 230 generated by the evaluation function generation process 500. The decision-tree learning algorithm 400 initially executes the feature ranking subroutine 600, discussed below in conjunction with FIG. 6, during step 410 to rank all features in the current dataset 300 using the evaluation function 230 and thereby form the root of the decision tree. Thereafter, the decision-tree learning algorithm 400 executes the selection/node creation subroutine 700, discussed below in conjunction with FIG. 7, during step 430 to select the best feature and create a node in the decision tree.

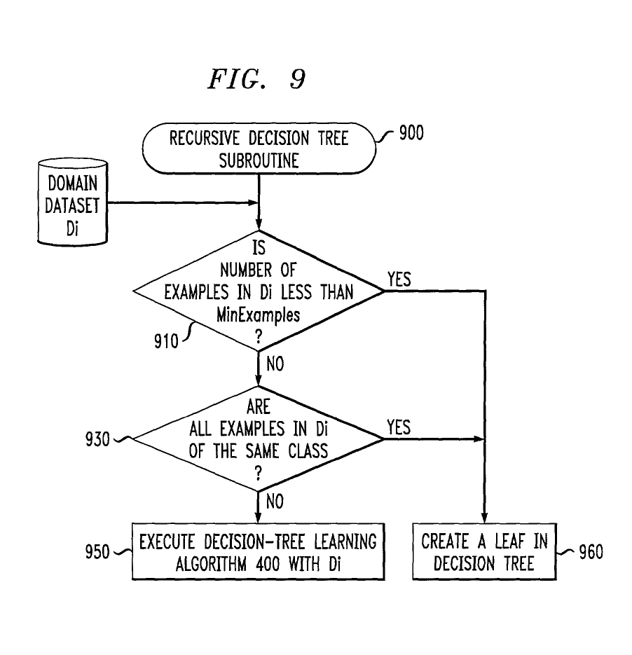

The decision-tree learning algorithm 400 executes the example discrimination subroutine 800, discussed below in conjunction with FIG. 8, during step 450 to separate the examples according to their feature values. Step 450 divides the domain dataset into mutually exclusive examples, one for each possible feature value. The recursive decision tree subroutine 900, discussed below in conjunction with FIG. 9, is executed during step 470 to recursively apply the procedure on each example subset until a specified stopping criteria is satisfied, in which case the node becomes terminal (i.e., a leaf).

A test is performed during step 480 to determine if there are additional dataset(s) to be processed. If it is determined during step 480 that there are additional dataset(s) to be processed, then program control returns to step 410 to process the next dataset. If, however, it is determined during step 480 that there are no additional dataset(s) to be processed, then program control terminates and the final model 250 has been identified.

FIG. 5 is a flow chart describing the evaluation function generation process 500. As previously indicated, the evaluation function generation process 500 incorporates features of the present invention to generate one or more evaluation functions using the unified framework. The evaluation function generation process 500 generates an evaluation function using specified values for four different parameters. As discussed further below in a section entitled “Unified Framework to Represent and Generate Evaluation Functions,” the first parameter is an impurity measure, F, specified during step 510 to characterize the quality of the partitions induced by each of the candidate features on the domain dataset. The second parameter is a weight vector, θ, specified during step 520 to indicate the weight given to different factors related to the partitioning of the domain dataset. The third parameter is a weight distance, α, specified during step 530 that varies the relative importance of the distance between any two examples. In other words, large values for α narrow attention to only the closest neighboring examples while small values for α extend attention to examples lying far apart. In the extreme case, where α=0, all examples are considered equally, irrespective of distance. The fourth parameter is the update factor, f_{α}, specified during step 540 and is a distance function between examples (rows) in the domain dataset (indicating the distance between examples).

The values specified for the four parameters completely specify a new evaluation function which is generated during step 550. It can be shown that a specific setting for these parameters can generate all forms of traditional and discrimination-based functions. Thus, the proposed new family of evaluation functions unveils a space of functions much larger than previously thought. Adopting the new family of functions has the potential of producing more accurate models than it was previously possible with prior art.

FIG. 6 is a flow chart describing an exemplary embodiment of the feature-ranking subroutine 600 executed by the decision-tree learning algorithm 400. As previously indicated, the decision-tree learning algorithm 400 executes the feature-ranking subroutine 600 to rank all features in the current dataset 300 using the evaluation function 230. As shown in FIG. 6, the feature-ranking subroutine 600 computes a score, F(X), during step 610 for each feature, X, in the dataset according to the quality of the partitions induced by the feature in the domain dataset. The features are then sorted during step 630 based on their individual scores. Program control then returns to the calling function (the decision-tree learning algorithm 400).

FIG. 7 is a flow chart illustrating an exemplary embodiment of the feature selection/tree-node creation subroutine 700. As previously indicated, the decision-tree learning algorithm 400 executes the feature selection/tree-node creation subroutine 700 to select the best feature and create a node in the decision tree. As shown in FIG. 7, the feature selection/tree-node creation subroutine 700 initially selects the feature, X, with highest score, F(X), during step 710. A tree node is created during step 730 labeled with the highest scoring feature, X. The created tree node contains the best feature, the number of examples at that node, and the majority class for examples in the node. Program control then returns to the calling function (the decision-tree learning algorithm 400).

FIG. 8 is a flow chart describing an exemplary implementation of the example discrimination subroutine 800. As previously indicated, the decision-tree learning algorithm 400 executes the example discrimination subroutine 800 to separate the examples according to their feature values. This subroutine 800 divides the domain dataset into mutually exclusive examples, one for each possible feature value. As shown in FIG. 8, a domain dataset 300 is divided into mutually exclusive subsets D1 through Dm during step 810 with each subset Di characterized by having examples with the same value for the feature at that node.

FIG. 9 is a flow chart describing an exemplary implementation of the recursive decision tree subroutine 900. As previously indicated, the decision-tree learning algorithm 400 executes the recursive decision tree subroutine 900 to apply the procedure on each example subset until a specified stopping criteria is satisfied, in which case the node becomes terminal (i.e., a leaf). As shown in FIG. 9, the recursive decision tree subroutine 900 receives the current dataset, Di, as input and initially performs a test during step 910 to determine if the number of examples in the current dataset is less than a specified value, MinExamples.

If it is determined during step 910 that the number of examples in the current dataset is less than a specified value, MinExamples, then a leaf is created during step 960 in the decision tree. If, however, it is determined during step 910 that the number of examples in the current dataset is not less than a specified value, MinExamples, then a further test is performed during step 930 to determine if all of the examples in the current dataset are of the same class.

If it is determined during step 930 that all of the examples in the current dataset are of the same class, then a leaf is created during step 960 in the decision tree. If, however, it is determined during step 930 that all of the examples in the current dataset are not of the same class, then program control proceeds to step 950 where the decision-tree learning algorithm 400 is again executed (recursively) with the current dataset. In this manner, the same decision-tree procedure is recursively applied on each example subset until the stopping criteria is satisfied. The algorithm 900 stops partitioning the example subset if any of the two conditions is met: 1) the number of examples is less than some predefined threshold (step 910), or 2) the classes of all examples are the same (step 930), i.e., examples are class uniform. If any of the two conditions is met, the algorithm creates a leaf during step 960. If not, the algorithm 900 calls itself recursively using the example subset Di.

### Unified Framework to Represent and Generate Evaluation Functions

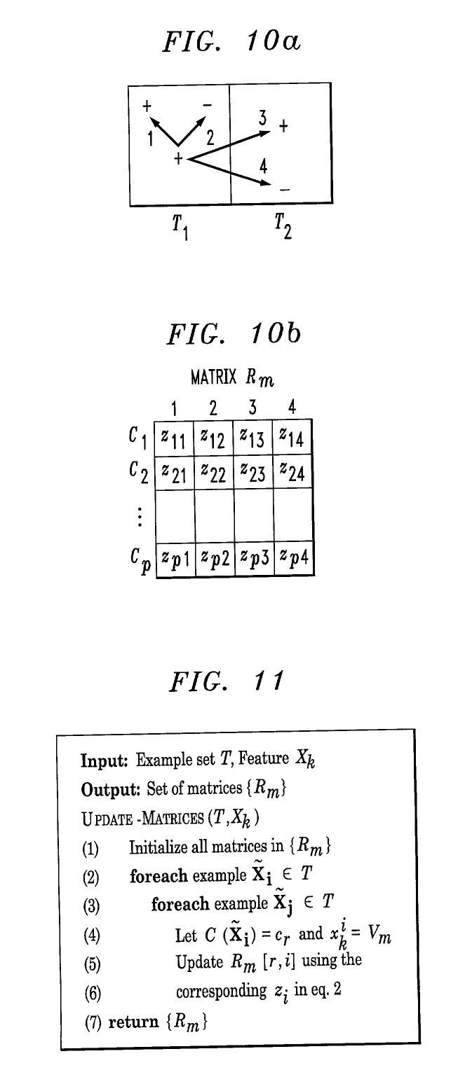

To evaluate the quality of feature Xₖ in the unified framework of the present invention, the strategy of discrimination-based metrics is extended by exploiting additional information between any pair of examples. It is noted that feature Xₖ divides the training set T into a set of subsets {Tₘ}, one for each feature value. FIG. 10a illustrates the possible scenarios in terms of the class agreement between any pair of examples \tilde{X}i and \tilde{X}j. The two examples may fall in the same subset (e.g., T₁) and either agree in their class values or not (cases 1 and 2, respectively), or the examples may belong to different subsets (e.g., T₁ and T₂) and either agree in their class values or not (cases 3 and 4, respectively). Although FIG. 10a shows two classes only, any number of possible classes is possible, as would be apparent to a person of ordinary skill in the art.

The general approach of the present invention consists of comparing each example to every other example and storing counts for each of these four possible cases separately. Ideally, high counts should be observed for cases 1 and 4, and low scores for cases 2 and 3, since case 1 (xₖⁱ=xₖ^{j} and C(\tilde{X}i)=C(\tilde{X}j)) and case 4 (xₖⁱ≠xₖ^{j} and C(\tilde{X}i) ≠C(\tilde{X}j)) ensure the properties of class uniformity (extent of distribution of examples) and discrimination power (how much the feature contributes to predicting class), respectively, whereas case 2 (xₖⁱ=xₖ^{j} and C(\tilde{X}i)≠C(\tilde{X}j)) and case 3 (xₖⁱ≠xₖ^{j} and C(\tilde{X}i) =C(\tilde{X}j)) work against them.

Thus, the four possible cases for the two class situation of FIG. 10a may be expressed as follows:

| CASE | | | EMPHASIZED |
|---|---|---|---|
| NUMBER | SUBSET | CLASS | PROPERTY |
| 1 | SAME | SAME | CLASS |
| | | | UNIFORMITY |
| 2 | SAME | DIFFERENT | NEGATIVE |
| 3 | DIFFERENT | SAME | NEGATIVE |
| 4 | DIFFERENT | DIFFERENT | DISCRIMINATION |
| | | | POWER |

The present invention works as follows. For each induced example subset Tm, a count matrix Rm is associated with it. If p is the number of possible class values, each Tₘ is characterized by a matrix Rₘ of size p×4, where row r is a count vector \tilde{Z}r=(Zᵣ₁, Zᵣ₂, zᵣ₃, Zᵣ₄) which stores the counts for each of the four cases involving examples in class r, as shown in FIG. 10b. Each count matrix Rm has four columns corresponding to the four possible cases in FIG. 10a. Each row in FIG. 10b corresponds to a different class. In addition, a weight vector is defined as \tilde{θ}=(θ₁, θ₂, θ₃, θ₄,), θᵢ∈[0,1], that modulates the contribution of the four counts or columns of the count matrix Rₘ. Thus, each component of the weight vector indicates how much weight to give to class uniformity (extent of distribution of examples) and discrimination power, respectively.

The updating of each row, \tilde{Z}r, of the matrix Rₘ is now explained. Given an example \tilde{X}i in class r, for every other example \tilde{X}j, the two examples under consideration are compared to classify according to one of the four cases and the corresponding one of the four counts zᵣᵢ is updated. The appropriate zᵣᵢ is updated as follows:

zᵣᵢ=zᵣᵢ+\tilde{θ}ₗ·f_{α}(x) (1)

where x=D(\tilde{X}i, \tilde{X}j) is the distance between the two examples. It is assumed that all features are nominal such that the distance between two feature values may be either zero or one. The function f_{α} indicates the closeness of the examples and thus decreases with x and may have one of several forms (see, S. J. Hong, Use of Contextual Information for Feature Ranking and Discretization, IEEE Transactions of Knowledge and Data Engineering (1997)):

$$k {f}_{α} ( x ) = \frac{1}{{x}^{α}} or {f}_{α} ( x ) = \frac{1}{{2}^{α \cdot x}} \qquad ( 2 )$$

Large values for a narrow attention to only the closest neighboring examples. Small values for α extend attention to examples lying far apart. In the extreme case, where α=0, all examples are considered equally, irrespective of distance. Thus, α enables the relative importance of the distance between any two examples to be varied.

As previously indicated, the vector \tilde{θ} modulates the degree of contribution of each of the four cases in FIG. 10. In particular, setting \tilde{θ}ᵢ to zero nullifies the contribution of the ith case. It will be shown how varying the values of \tilde{θ} puts more weight on either class uniformity or discrimination power (cases 1 and 4).

FIG. 11 describes the computation of the set of matrices {Rₘ}. In essence, every example is compared against all other examples in T, while the counts for each matrix Rₘ are updated. For simplicity, the algorithm is described for a single feature Xₖ, but the double loop in lines 2-3 can be done over all features. The complexity of the algorithm is on the order of T². A matrix Rₘ is selected according to the value of feature Xk′ in \tilde{X}i. The row index corresponds to the class value of \tilde{X}i, C(\tilde{X}i). The column index corresponds to the case to which \tilde{X}i and \tilde{X}j belong (FIG. 10a). Once the matrix entry is located, the corresponding zᵢ is updated as indicated above.

Lines 2-3 in FIG. 11 cycle through all examples in T. There is no need to limit the second loop to the closest examples because the update function depends on distance and is regulated by parameter α. As discussed further below, the present invention allows comparison of pairs of identical examples.

The training set T also gives rise to a matrix R, as a function of the set {Rₘ}, but because examples in T cannot be compared to different example sets, all columns in R corresponding to cases 3 and 4 must equal zero. The evaluation metric of the present invention evaluates the quality of a feature Xₖ as a function of the matrix R for the training set T and the matrix Rₘ for each of the induced subsets {Tₘ} (computed as shown in FIG. 11):

M(Xₖ)=F(R,{Rₘ}) (3)

Finally, the unified framework for evaluation metrics Π is a 4-tuple containing all the parameters necessary to define a metric of the form defined in the previous equation:

Π=(F,\tilde{θ},α,f_{α}) (4)

### Instances Of The Unified Framework

As discussed below, the unified framework for evaluation metrics covers traditional, or purity-based metrics, and also discrimination-based metrics. In particular, for a specific setting on the parameters of framework Π, it is possible to derive all traditional metrics.

As previously indicated, the function F defines how to measure the quality or impurity of a feature based on class proportions. In general the function F assigns a score to the matrix Rm that positively weights counts in columns 1 and 4, and negatively weights counts in columns 2 and 3. It can be shown that for a specific setting of Π all class proportions can be derived. Consider the result of running the algorithm in FIG. 11 with \tilde{θ}=(1,0,0,0). Since only class uniformity is of concern (FIG. 10, Case 1), only pairs of examples with the same class value and the same feature value are considered. Assume f_{α}(x=0)=1 and $f_{α}(x≠0)=0 (x is the distance D(\tilde{X}i, \tilde{X}j) between the two examples). Since f_{α}(x)=1 only when the distance between examples is zero, the comparisons are limited to pairs of identical examples. Therefore, the counts on each matrix Rₘ are zero in columns 2-4, and column 1 reflects the number of examples of each class when the feature value is fixed. These counts are sufficient to compute F: class counts can be easily converted into class proportions by dividing over the sum of all entries in column 1, i.e., by dividing over ΣᵢRₘ[i,1].

Both Relief and Contextual Merit are instances of the unified framework Π. For Contextual Merit, consider the result of running the algorithm in FIG. 11 with \tilde{θ}=(0,0,0,1), α=2, and f_{á}=1/x^{á}=1/x². Now, only discrimination power is of concern (FIG. 10, Case 4), and examples are compared with different class values and different feature values. The counts on each matrix Rₘ are zero on columns 1-3; the sum of the values along column 4 over all {Rₘ}, Σₘ(ΣₗRₘ[i,1]), is exactly the output produced by Contextual Merit when each example in T is compared against all other examples.

For Relief, consider the result of running the algorithm in FIG. 10 with \tilde{θ}=(0,0,1,1), and f_{á}(x)=1 if x<α, and 0 otherwise; α takes the role of defining a threshold that allows comparison of only the α-nearest neighbors. Since \tilde{θ}=(0,0,1,1), discrimination power is favored but working against it is penalized. Examples are compared with different feature values irrespective of class value. The counts on each matrix Rₘ are zero in columns 1-2; the sum of the values along column 4 over all {Rₘ} minus the respective sum along column 3, Σₘ(ΣᵢRₘ[i,4]−Rₘ[i,3]), is the output produced by Relief for the appropriate value of á.

The unified framework Π adds versatility to the new family of metrics provided by the present invention by enabling modulating how much emphasis should be placed on class uniformity (or lack thereof) and discrimination power (or lack thereof).

### Instance of Π

In one preferred implementation, a simple model is adopted for the function F to assign a score to the matrix Rm that positively weights counts in columns 1 and 4, and negatively weights counts in columns 2 and 3. Generally, the selected function F adds the values over all matrices in {Rm} in columns 1 and 4, and subtracts the values in columns 2 and 3. This summation is performed for each feature value and then the weighted average is computed according to the number of examples in each example subset, as follows:

$$\begin{matrix}F = \frac{\vert {T}_{m} \vert}{T} {\sum }_{m} G ( {R}_{m} ) \\ G ( Rm ) is defined as follows \text{:} & ( 5 ) \\ G ( {R}_{m} ) = {\sum }_{i = 1}^{p} ( {R}_{m} [ i , 1 ] + {R}_{m} [ i , 4 ] - {R}_{m} [ i , 2 ] - {R}_{m} [ i , 3 ] ) & ( 6 )\end{matrix}$$

where p is the number of classes. The definition for G(Rm) corresponds to \tilde{θ}=(1,1,1,1), which can be regarded as a compromise between class purity and discrimination power. For the update function,

$${f}_{α} = \frac{1}{{2}^{α \cdot x}}$$

and α=0.1 are employed.

The disclosed framework Π enriches the information derived when a feature is used to partition the training set T by capturing all possible scenarios in terms of class agreement (or disagreement) between pairs of examples in T. Most metrics utilize only a small fraction of the information contained in the disclosed framework Π. The disclosed framework, Π, therefore, provides a broader view of the space of possible metrics.

The performance of the present invention may also be improved by matching domain characteristics with the appropriate parameter settings in Π (equation 4). The flexibility inherent in the unified framework in finding a balance among several criteria suggests guiding the parameter settings according to the characteristics (i.e., meta-features) of the domain under analysis. For example, meta-features could be functions of the counts in the matrix R over the set T, where T corresponds to the whole training set Tₜᵣₐᵢₙ. Those counts provide information about the domain itself and relate directly to Π.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

It is to be understood that the embodiments and variations shown and described herein are merely illustrative of the principles of this invention and that various modifications may be implemented by those skilled in the art without departing from the scope and spirit of the invention.

What is claimed is:

1. A method for partitioning a domain dataset, said domain dataset having a plurality of examples, each of said examples characterized by at least one feature and one class value, said feature having a plurality of possible feature values, said method comprising the steps of:
establishing an evaluation function to partition said domain dataset, wherein said evaluation function includes a class uniformity measure and a discrimination power measure, and a weight for each of said class uniformity and discrimination power measures; and
partitioning said domain dataset using said evaluation function.

2. The method of claim 1, further comprising the step of obtaining a model that may be used to classify additional datasets.

3. The method of claim 1, wherein said partitioning step establishes nodes in a decision tree.

4. The method of claim 1, wherein said feature may be a conjunction of features and said partitioning step establishes rules for a rule-based classification system.

5. The method of claim 1, wherein said class uniformity measure is obtained by comparing each example in said domain dataset to other examples in said domain dataset; and obtaining a first count of a number of examples having a same feature value and same class value.

6. The method of claim 5, further comprising the step of offsetting said first count by a second count of a number of examples having a same feature value and a different class value.

7. The method of claim 1, wherein said discrimination power measure is obtained by comparing each example in said domain dataset to other examples in said domain dataset; and obtaining a third count of a number of examples having a different feature value and a different class value.

8. The method of claim 7, further comprising the step of offsetting said third count by a fourth count of a number of examples having a different feature value and a same class value.

9. The method of claim 1, wherein said evaluation function further comprises a weight distance, α, that establishes a relative importance of the distance between any two examples.

10. A method for partitioning a domain dataset, said domain dataset having a plurality of examples, each of said examples characterized by at least one feature and one class value, said feature having a plurality of possible feature values, said method comprising the steps of:
evaluating a class uniformity measure for each of said examples for every feature value;
evaluating a discrimination power measure for each of said examples for every feature value;
determining a score for each of said features using a function that considers both said class uniformity measure and said discrimination power measure;
selecting a feature having a highest score to use to partition said data; and
recursively applying said two evaluating steps and said determining and selecting steps until all of said examples are partitioned.

11. The method of claim 10, wherein said selecting step establishes a node in a decision tree.

12. The method of claim 10, wherein said feature may be a conjunction of features and said selecting step establishes a rule for a rule-based classification system.

13. The method of claim 10, wherein said partitioned examples provide a model that may be used to classify data.

14. The method of claim 10, wherein said step of evaluating a class uniformity measure further comprises the step of:
comparing each example in said domain dataset to other examples in said domain dataset; and
obtaining a first count of a number of examples having a same feature value and same class value.

15. The method of claim 14, further comprising the step of offsetting said first count by a second count of a number of examples having a same feature value and a different class value.

16. The method of claim 10, wherein said step of evaluating a discrimination power measure further comprises the step of:
comparing each example in said domain dataset to other examples in said domain dataset; and
obtaining a third count of a number of examples having a different feature value and a different class value.

17. The method of claim 16, further comprising the step of offsetting said third count by a fourth count of a number of examples having a different feature value and a same class value.

18. The method of claim 10, further comprising the step of varying a weight vector, θ, to establish a weight for each of said class uniformity and discrimination power measures.

19. The method of claim 10, further comprising the step of varying a weight distance, α, to establish a relative importance of the distance between any two examples.

20. A method for establishing an evaluation function for partitioning a domain dataset, said domain dataset having a plurality of examples, each of said examples characterized by at least one feature and one class value, said feature having a plurality of possible feature values, said method comprising the steps of:
providing one or more configurable parameters that evaluate a class uniformity measure and a discrimination power measure and provide a weight for each of said class uniformity and discrimination power measures; and
providing a configurable function that is based on said class uniformity measure and said discrimination power measure to determine a score for each of said features, said score used to identify a feature to partition said domain dataset.

21. The method of claim 20, wherein said class uniformity measure is obtained by comparing each example in said domain dataset to other examples in said domain dataset; and obtaining a first count of a number of examples having a same feature value and same class value.

22. The method of claim 21, further comprising the step of offsetting said first count by a second count of a number of examples having a same feature value and a different class value.

23. The method of claim 20, wherein said discrimination power measure is obtained by comparing each example in said domain dataset to other examples in said domain dataset; and obtaining a third count of a number of examples having a different feature value and a different class value.

24. The method of claim 23, further comprising the step of offsetting said third count by a fourth count of a number of examples having a different feature value and a same class value.

25. The method of claim 20, wherein said evaluation function further comprises a weight distance, α, that establishes a relative importance of the distance between any two examples.

26. A system for partitioning a domain dataset, said domain dataset having a plurality of examples, each of said examples characterized by at least one feature and one class value, said feature having a plurality of possible feature values, comprising:
a memory that stores computer-readable code; and
a processor operatively coupled to said memory, said processor configured to implement said computer-readable code, said computer-readable code configured to:
establish an evaluation function to partition said domain dataset, wherein said evaluation function includes a class uniformity measure and a discrimination power measure, and a weight for each of said class uniformity and discrimination power measures; and
partition said domain dataset using said evaluation function.

27. A system for partitioning a domain dataset, said domain dataset having a plurality of examples, each of said examples characterized by at least one feature and one class value, said feature having a plurality of possible feature values, comprising:
a memory that stores computer-readable code; and
a processor operatively coupled to said memory, said processor configured to implement said computer-readable code, said computer-readable code configured to:
evaluate a class uniformity measure for each of said examples for every feature value;
evaluate a discrimination power measure for each of said examples for every feature value;
determine a score for each of said features using a function that considers both said class uniformity measure and said discrimination power measure;
select a feature having a highest score to use to partition said data; and
recursively apply said two evaluating steps and said determining and selecting steps until all of said examples are partitioned.

28. A system for establishing an evaluation function for partitioning a domain dataset, said domain dataset having a plurality of examples, each of said examples characterized by at least one feature and one class value, said feature having a plurality of possible feature values, comprising:
a memory that stores computer-readable code; and
a processor operatively coupled to said memory, said processor configured to implement said computer-readable code, said computer-readable code configured to:
provide one or more configurable parameters that evaluate a class uniformity measure and a discrimination power measure and provide a weight for each of said class uniformity and discrimination power measures; and
provide a configurable function that is based on said class uniformity measure and said discrimination power measure to determine a score for each of said features, said score used to identify a feature to partition said domain dataset.

29. An article of manufacture for partitioning a domain dataset, said domain dataset having a plurality of examples, each of said examples characterized by at least one feature and one class value, said feature having a plurality of possible feature values, comprising:
a computer readable medium having computer readable code means embodied thereon, said computer readable program code means comprising:
a step to establish an evaluation function to partition said domain dataset, wherein said evaluation function includes a class uniformity measure and a discrimination power measure, and a weight for each of said class uniformity and discrimination power measures; and
a step to partition said domain dataset using said evaluation function.

30. An article of manufacture for partitioning a domain dataset, said domain dataset having a plurality of examples, each of said examples characterized by at least one feature and one class value, said feature having a plurality of possible feature values, comprising:
a computer readable medium having computer readable code means embodied thereon, said computer readable program code means comprising:
a step to evaluate a class uniformity measure for each of said examples for every feature value;
a step to evaluate a discrimination power measure for each of said examples for every feature value;
a step to determine a score for each of said features using a function that considers both said class uniformity measure and said discrimination power measure;
a step to select a feature having a highest score to use to partition said data; and
a step to recursively apply said two evaluating steps and said determining and selecting steps until all of said examples are partitioned.

31. An article of manufacture for establishing an evaluation function for partitioning a domain dataset, said domain dataset having a plurality of examples, each of said examples characterized by at least one feature and one class value, said feature having a plurality of possible feature values, comprising:
a computer readable medium having computer readable code means embodied thereon, said computer readable program code means comprising:
a step to provide one or more configurable parameters that evaluate a class uniformity measure and a discrimination power measure and provide a weight for each of said class uniformity and discrimination power measures; and
a step to provide a configurable function that is based on said class uniformity measure and said discrimination power measure to determine a score for each of said features, said score used to identify a feature to partition said domain dataset.
